(19) United States
(12) Patent Application Publication
(10) Pub. No.: US 2012/0178286 A1
(43) Pub. Date: Jul. 12, 2012

(54) BATTERY CONNECTOR AND METHOD OF MAKING A BATTERY CONNECTOR

(75) Inventors: Douglas Alan Schlaudroff, Fort Wayne, IN (US); John Jacob, Fort Wayne, IN (US)

(73) Assignee: International Truck Intellectual Property Company, LLC, Lisle, IL (US)

(21) Appl. No.: 13/394,403

(22) PCT Filed: Sep. 25, 2009
(86) PCT No.: PCT/US2009/058311

§ 371 Date: Mar. 6, 2012

(51) Int. Cl. H01M 2/20; H01R 43/048; H01R 11/11

(52) U.S. Cl. 439/504; 29/857; 29/863

(57) ABSTRACT

A battery connector includes a first end terminal, at least one intermediate terminal and a second end terminal. The at least one intermediate terminal is in communication with the first end terminal via a first flexible cable. The first flexible cable is affixed to the at least one intermediate terminal and the first end terminal. The second end terminal is in communication with the at least one intermediate terminal via a second flexible cable, the second flexible cable being affixed to the at least one intermediate terminal and the second end terminal.

### BACKGROUND

The present disclosure relates generally to a battery connector and a method of making a battery connector.

A battery pack is a set of any number of identical batteries or individual battery cells. They may be configured in a series, parallel or a mixture of both to deliver the desired voltage, capacity, or power density. Components of battery packs include the individual batteries or cells, and the interconnects which provide electrical conductivity between them. Interconnects are also found in batteries as they are the part which connects each cell. Batteries are typically arranged in series strings.

Battery packs may be changed into or out of a device. This allows multiple packs to deliver extended runtimes, freeing up the device for continued use while charging the removed pack separately. Battery packs may flexible in both design and implementation. This allows the use of cheaper high-production cells or batteries to be combined into a pack for nearly any application. Furthermore, at the end of product life, batteries can be removed and recycled separately, reducing the total volume of hazardous waste.

As shown in FIGS. 1A to 1C together, traditional battery connectors 110, 110′ may include a clamp 114 having a through hole 116 in which a screw 118 is mounted and screwed up with a wing nut 120 to secure an electrical cable 122 to the clamp 114. In lieu of a clamp 114, a base 112 may be used as shown in FIG. 1C, the base 112 may be a standard ring 46 as shown in FIG. 1C.

With respect to the clamp 114, the clamp 114 may include two symmetrical clamping arms 126 integral with the clamp base 128 as shown in FIGS. 1A and 1B. The two clamping arms 126 wherein each clamping arm 126 has a respective eyed end 128 which is configured to receive a screw 130 or other mechanical fastener. When the clamping arms 126 are attached to a post 132 of a battery, a screw bolt 134 is installed to fasten the eyed ends 128 of the clamping arms 126 together. By installing a mechanical fastener such as a screw 130 into the eyed ends 128 of the clamping arms 126, the clamping arms 126 are secured to the battery post firmly. Furthermore, multiple cables 136 may be mounted across multiple corresponding posts 132 of multiple batteries 140 while multiple cables 138 are mounted across multiple negative posts 132 of multiple batteries 140 as shown in FIG. 2.

### SUMMARY

A Embodiments described herein provide a battery connector and a method of making a battery connector. One embodiment provides a battery connector that includes a first end terminal, at least one intermediate terminal and a second end terminal. The at least one intermediate terminal is in communication with a first end terminal via a first flexible cable. The first flexible cable is affixed to the at least one intermediate terminal and the first end terminal. The second end terminal is in communication with the at least one intermediate terminal via a second flexible cable, the second flexible cable being affixed to the intermediate terminal and the second end terminal.

Another embodiment provides a method for manufacturing making a battery connector. In one method, a first end terminal, a second end terminal, and at least one intermediate terminal are provided. The first end terminal is connected to the at least one intermediate terminal with a first flexible cable. The at least one intermediate terminal is connected to the second end terminal with a second flexible cable.

### DESCRIPTION OF THE DRAWINGS

FIG. 1A shows an expanded, perspective, partial view of a battery interconnection joint of the prior art.

FIG. 1B shows a partial, plan view of a battery post having an connector joint of the prior art.

FIG. 1C shows an expanded, perspective, partial view of another battery interconnection joint of the prior art.

FIG. 2 shows a perspective view of the battery system of the prior art where the positive terminals are interconnected together and the negative terminals are interconnected together through a series of cords.

FIG. 3A shows a partial plan view of an embodiment of a first end of the battery connector described herein.

FIG. 3B shows a partial, cut-a-way side view of an embodiment of an end terminal of the battery connector described herein.

FIG. 4 shows a plan view of an embodiment described herein.

FIG. 5A shows a plan, partial view of an embodiment of an intermediate terminal described herein.

FIG. 5B shows a partial, side, cut-a-way view of an embodiment of an intermediate terminal described herein.

FIG. 6 shows a flow chart illustrating an embodiment of a method for making a battery connector described herein.

### DETAILED DESCRIPTION

Embodiments described herein include a battery connector 10 for a battery system and a method for making a battery connector 10. The battery connector 10 of the present disclosure allows a user to connect battery posts (shown as 132 in FIG. 2) between individual sets of batteries (shown as 140 in FIG. 2) with a single component while at the same time reducing stack-up at the battery posts thereby improving the transmission in electricity and the battery pack arrangement.

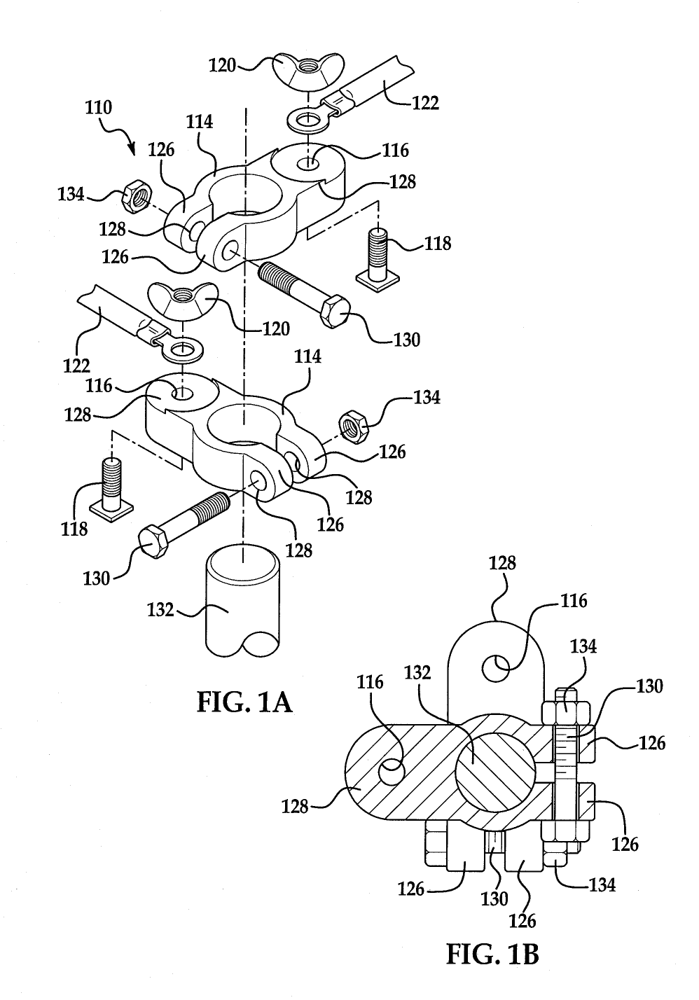

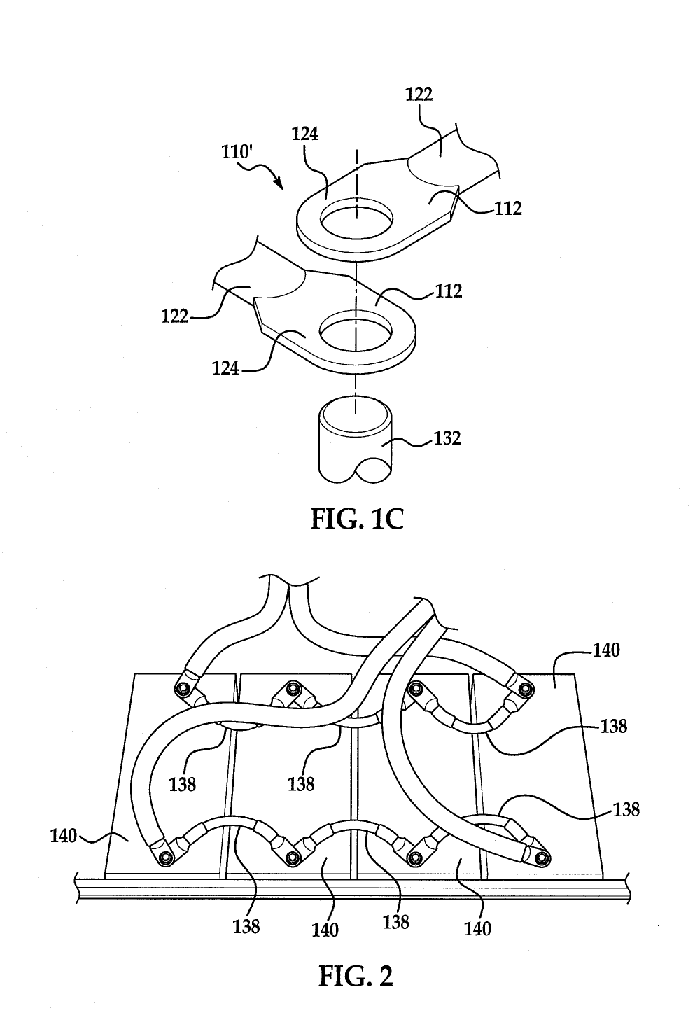

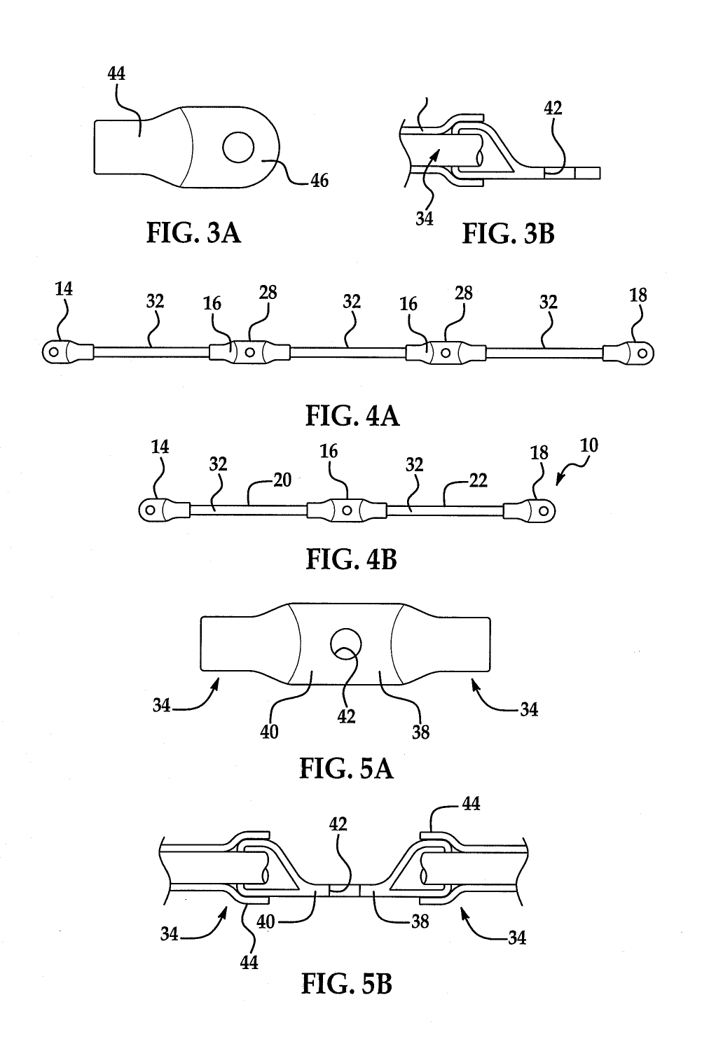

Referring now to FIG. 4B, a battery connector 10 of the present disclosure may include a first end terminal 14, an intermediate terminal 16, a first flexible cable 20, a second end terminal 18 and a second flexible cable 22. A first end terminal 14 is disposed at one end of the battery connector 10. The first end terminal 14 may be a standard ring 46 that is operatively configured to be mounted on a battery post (shown as 132 in FIG. 1A). The standard ring 46 defines an opening 47 that receives the battery post. As shown in FIG. 3B, the standard ring 46 may include one attachment point 34 for a first flexible cable 20. Referring to FIG. 3B, the attachment point 34 may be formed in the first end terminal 14 wherein the attachment joint is integral to the standard ring 46 and is crimped around the first end 24 of the first flexible cable 20 as shown in FIG. 3B. An intermediate terminal 16 is in communication with a first end terminal 14 through the first flexible cable 20. The first flexible cable 20 may be affixed to or integral with the intermediate terminal 16 at a second end 26 of the first flexible cable 20.

Any appropriate number of intermediate terminals 16 may be implemented with appropriately modified embodiments of the connector 10. For example, a second intermediate terminal 28, a third intermediate terminal, etc. with flexible cables 32 between the intermediate terminals 16 depending on the number of batteries (shown as 140 in FIG. 2) that need to be connected in the battery pack may be used. Accordingly, dimensions of the battery connector 10 may vary depending on the number of posts that need to be connected. The flexible nature of the cables 16 between the terminals 16, 14, 18 allow for movement of the cable 16 between the batteries. The flexible nature of the cables 16 further allows for some battery movement within the battery pack.

In the embodiment shown in FIG. 4A, a second intermediate terminal 28 is implemented with a first intermediate terminal 28. The second intermediate terminal 28 is in operative communication with the first intermediate terminal 28 via a flexible cable 22. The flexible cable 32 may be affixed to or integral to the intermediate terminals 28. As shown in FIG. 5B, the intermediate terminals 28 include two attachment points 34 for flexible cables 32. The attachment point 34 may be formed in the intermediate terminals 28 wherein the attachment joint is crimped around the an end of a flexible cable 32 as shown in FIG. 3B

At the end of the battery connector 10 opposite the first terminal end, a second end terminal 18 is included. Similar to the first end terminal 14, the second end terminal 18 is disposed at one end of the battery connector 10. The second end terminal 18 may be a ring 46 (shown in FIG. 3A) that is operatively configured to be mounted on a battery post (shown as 132 in FIG. 1A). The standard ring 46 defines an opening that receives the battery post. The standard ring 46 may include one attachment point 34 for a flexible cable 32. The attachment point 34 may be formed in the second end terminal 18 wherein the attachment joint is crimped around the an end of a flexible cable 32 as shown in FIG. 3B.

It is to be understood that crimping the standard ring 46 about the flexible cable (as shown in FIG. 3B) is only one non-limiting example of joining the flexible cable 32 to the second end terminal 18. In yet another non-limiting example, the standard ring 46 may have a different type of attachment point 34 such that the flexible cable may simply wind about the attachment point 34. The flexible cable may also be joined to the stamped terminal through an electrical quick connection. The aforementioned examples are intended to be non-limiting examples which illustrate only some of a variety of ways in which the electrical cable can be joined to the terminal. Given that the first end terminal 14 and the second end terminal 18 do not require additional cable to be routed to yet another battery post, there is only one attachment structure for flexible cable at the first end terminal 14 and the second end terminal 18.

The battery interconnect cable may be made of an electrically conductive material, such as, but not limited to copper and aluminum. Accordingly, as a non-limiting example, the first terminal, the first flexible cable 20, the second terminal, the second flexible cable 22 and the third terminal may all be formed from copper.

Referring now to the non-limiting examples shown in FIGS. 4, 5A, and 5B together, the intermediate terminals may each be formed by a flat stamped section 40 of an electrically conductive tube 38 wherein the flat stamped section 40 defines a terminal opening 42. The terminal opening 42 may be operatively configured to receive a battery post (shown as 132 in FIGS. 1A and 1C) so that the intermediate terminal 16 is mounted to the battery 140. Referring now to FIG. 5B, it is also to be understood that the intermediate terminals 16 each have at least one opening or attachment point 34 adjacent to or on each side of the flat stamped section. In the manufacturing process, the attachment point 34 may be the opened end of the tube that is operatively configured to receive one of flexible cables. Each of the tube openings may be crimped around an end of one of the corresponding flexible cables 32 as shown in FIG. 5B.

Similar to the first end terminal 14 and the second end terminal 18, the intermediate terminals 16 may be joined to the flexible cables 32 in a joint that is different from the crimped joint described above. Each of the intermediate terminals 16 may have a different type of attachment point 34 on each side of the intermediate terminal 16 such that the flexible cable 32 on each side of the intermediate terminal 16 may simply wind about the attachment point 34. The flexible cable 32 may also be joined to the stamped intermediate terminal 16 through an electrical quick connection (not shown). The aforementioned examples are intended to be non-limiting examples which illustrate only some of a variety of ways in which the flexible cable 32 can be joined to the intermediate terminal 16.

Given that the tube 38 and the flexible cable 32 are made of electrically conductive material such as, but not limited to copper, aluminum or the like, electricity is readily transferred between the crimped tube 38 and the flexible cables 32. Furthermore, as shown in FIGS. 4, 5A and 5B, the flexible cables 32 in addition to the area where the flexible cable 32 and the terminal 14, 16, 18 join are covered with an insulating polymeric material 44.

In yet another embodiment, the intermediate terminal 28 may be configured such that the first and second attachment points 34 (shown in FIG. 5B) on the intermediate terminal 28 are adjacent to each other. In one example where the attachment points 34 are open ends 33 of a tube 38 that are crimped about the flexible cable 32, this may be achieved by having the stamped tube 38 bent so as to push each end of the tube 38 together (not shown). This example arrangement may be helpful when the batteries in the battery pack are arranged in a unique pattern. However, given that batteries in a battery pack are traditionally laid in series as shown in FIG. 2, the first and second attachment points 34 may be opposite each other, as shown in FIGS. 5A and 5B. When batteries 140 in a battery pack are laid in series, the arrangement where the attachment points 34 are opposite each other may be beneficial in that the flexible cables 32 are routed toward their next connection point (such as the other battery post 12).

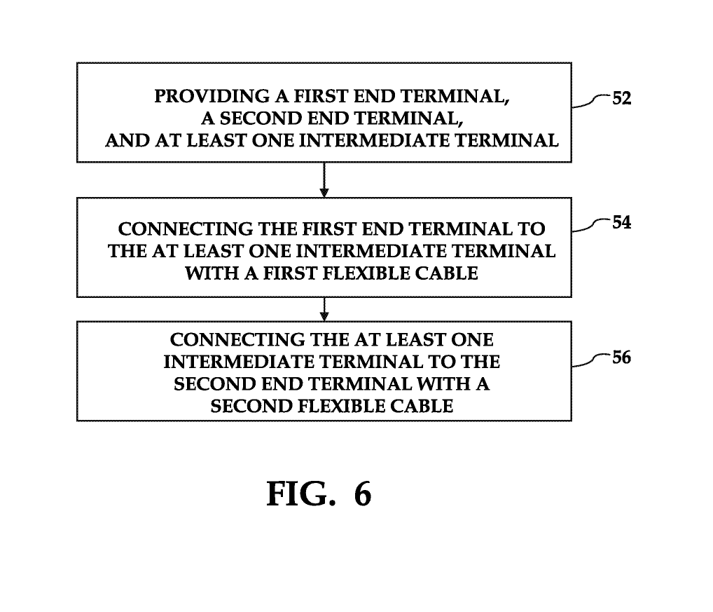

Another embodiment provides a method for making a battery connector 10. The method includes the steps of: (1) providing a first end terminal, a second end terminal, and at least one intermediate terminal (shown as 52 in FIG. 6); (2) connecting the first end terminal to the at least one intermediate terminal with a first flexible cable; (shown as step 54 in FIG. 6) and (3) connecting the at least one intermediate terminal to the second end terminal with a second flexible cable (shown as step 56 in FIG. 6).

It is to be understood that the step of connecting the first end terminal 14 to the at least one intermediate terminal 16 with a first flexible cable 20 may include crimping an attachment point of the first end terminal around an end of the first flexible cable (see FIG. 3B). Moreover, the step of connecting the at least one intermediate terminal to the second end terminal with a second flexible cable (step 54) may also include crimping an attachment point of the second end terminal around an end of the second flexible cable (see FIG. 3B). Likewise, the step of connecting the first and second flexible cables 20, 22 to an intermediate terminal 16 (step 56) may involve crimping the intermediate terminal 16 around the first and second flexible cables 20, 22 (shown in FIG. 5B).

What is claimed is:

1. A battery connector comprising:
a first end terminal;
at least one intermediate terminal in communication with the first end terminal via a first flexible cable, the first flexible cable being affixed to the at least one intermediate terminal and the first end terminal; and
a second end terminal in communication with the at least one intermediate terminal via a second flexible cable, the second flexible cable being affixed to the at least one intermediate terminal and the second end terminal.

2. The battery connector as defined in claim 1 wherein the first end terminal, the first flexible cable, the at least one intermediate terminal, the second flexible cable, and the second end terminal are integral.

3. The battery connector as defined in claim 1 wherein the first end terminal, the at least one intermediate terminal, and the second end terminal are each formed from copper.

4. The battery connector as defined in claim 1 wherein the first flexible cable and the second flexible cable are each formed from an electrically conductive material.

5. The battery connector as defined in claim 4 wherein the at least one intermediate terminal is formed by a flat stamped section of an electrically conductive tube wherein the flat stamped section defines an opening, the opening being operatively configured to be mounted to a battery post.

6. The battery connector as defined in claim 5 wherein the at least one intermediate terminal includes an open tube on each side of the flat stamped section, the open tube is operatively configured to be crimped around the first flexible cable and the second flexible cable.

7. The battery connector as defined in claim 6 wherein the open tube is crimped around an end of one of the first flexible cable and the second flexible cable.

8. The battery connector as defined in claim 4 wherein the first flexible cable and the second flexible cable are each covered with an insulating layer.

9. A method for making a battery connector, the method comprising the steps of:
providing a first end terminal, a second end terminal, and at least one intermediate terminal;
connecting the first end terminal to the at least one intermediate terminal with a first flexible cable; and
connecting the at least one intermediate terminal to the second end terminal with a second flexible cable.

10. The method for manufacturing a battery connector as defined in claim 9, wherein the step of connecting the first end terminal to the at least one intermediate terminal with the first flexible cable includes crimping an attachment point of the first end terminal around an end of the first flexible cable.

11. The method for manufacturing a battery connector as defined in claim 9 wherein the first end terminal, the intermediate terminal, and the second end terminal are each formed from copper.

12. The method for manufacturing a battery connector as defined in claim 9 wherein the at least one intermediate terminal is formed by a flat stamped section of an electrically conductive tube wherein the flat stamped section defines an opening, the opening being operatively configured to be mounted to a battery post.

13. The method for manufacturing a battery connector as defined in claim 9 wherein the first end terminal, the at least one intermediate terminal, and the second end terminal are each formed from an electrically conductive material.

14. The method as defined in claim 13 wherein the electrically conductive material is copper.
